(19) United States
(12) Patent Application Publication
(10) Pub. No.: US 2025/0225508 A1
(43) Pub. Date: Jul. 10, 2025

(54) COOPERATION SUPPORT METHOD

(71) Applicant: NEC CORPORATION, Minato-ku, Tokyo (JP)

(72) Inventor: Katsuhiko ISHIDA, Tokyo (JP)

(73) Assignee: NEC CORPORATION, Minato-Ku, Tokyo (JP)

(21) Appl. No.: 18/853,199

(22) PCT Filed: Apr. 7, 2023
(86) PCT No.: PCT/JP2023/014367

§ 371 Date: Oct. 1, 2024

(30) Foreign Application Priority Data
Apr. 25, 2022 (JP) 2022-071414

(51) Int. Cl. G06Q 20/38; G06Q 20/06

(52) U.S. Cl. CPC G06Q 20/381; G06Q 20/065

(57) ABSTRACT

A cooperation support apparatus of the present invention includes: a providing unit that provides a first business operator with previously registered selling information representing information on selling by a second business operator; an acquiring unit that acquires selling measure information representing a selling measure in cooperation with the second business operator by the first business operator, and sales information relating to selling by the second business operator; and a calculating unit that calculates token information having monetary value to be provided by the second business operator to the first business operator, based on the selling measure information by the first business operator and the sales information by the second business operator.

### TECHNICAL FIELD

The present invention relates to a cooperation support method, a cooperation support apparatus, and a storage medium.

### BACKGROUND ART

Patent Literature 1 describes cooperation in selling products and the like between a plurality of business operators. For example, it is described that one store introduces a product from another store to a customer who has purchased a product from the one store. Specifically, in Patent Literature 1, first, introduction information containing product information of another store to be an introduction destination is written on the membership card or receipt of a customer who has purchased a product from one store to be an introduction source. Then, the other store that is the introduction destination acquires the introduction information presented by the customer, sells a product from the other store, and calculates a commission to be paid to the store that is the introduction source. This allows an introduction destination store to sell a product to a customer introduced by an introduction source and allows the introduction source store to obtain an introduction fee, resulting in a selling cooperation that benefits the both.

### CITATION LIST

### Patent Literature

Patent literature 1: Japanese Patent Publication No. 4101176

### SUMMARY OF INVENTION

### Technical Problem

However, according to the abovementioned selling cooperation, a store to be an introduction destination waits for a store to be an introduction source to introduce a customer and cannot promote further selling cooperation, resulting in a problem that selling promotion cannot be conducted. Moreover, not only selling of products in stores but also cooperation between business operators cannot be promoted in any business, and selling promotion cannot be conducted.

Accordingly, an object of the present invention is to solve the abovementioned problem that promotion of selling cooperation between business operators cannot be conducted.

### Solution to Problem

A cooperation support method as an aspect of the present invention includes: providing a first business operator with previously registered selling information representing information on selling by a second business operator; acquiring selling measure information representing a selling measure in cooperation with the second business operator by the first business operator, and sales information relating to selling by the second business operator; and calculating token information having monetary value to be provided by the second business operator to the first business operator, based on the selling measure information by the first business operator and the sales information by the second business operator.

Further, a cooperation support apparatus as an aspect of the present invention includes: a providing unit that provides a first business operator with previously registered selling information representing information on selling by a second business operator; an acquiring unit that acquires selling measure information representing a selling measure in cooperation with the second business operator by the first business operator, and sales information relating to selling by the second business operator; and a calculating unit that calculates token information having monetary value to be provided by the second business operator to the first business operator, based on the selling measure information by the first business operator and the sales information by the second business operator.

Further, a computer program as an aspect of the present invention includes instructions for causing a computer to execute processes to: provide a first business operator with previously registered selling information representing information on selling by a second business operator; acquire selling measure information representing a selling measure in cooperation with the second business operator by the first business operator, and sales information relating to selling by the second business operator; and calculate token information having monetary value to be provided by the second business operator to the first business operator, based on the selling measure information by the first business operator and the sales information by the second business operator.

### Advantageous Effects of Invention

With the configurations as described above, the present invention enables promotion of selling cooperation between business operators.

### BRIEF DESCRIPTION OF DRAWINGS

FIG. 1 is a schematic view of the overall configuration of a cooperation support system in a first example embodiment of the present invention.

FIG. 2 is a block diagram showing the configuration of the cooperation support system disclosed in FIG. 1.

FIG. 3 is a sequence diagram showing the operation of the cooperation support system disclosed in FIG. 1.

FIG. 4 is a view showing the flow of data in the cooperation support system disclosed in FIG. 1.

FIG. 5 is a view showing the flow of data in the cooperation support system disclosed in FIG. 1.

FIG. 6 is a view showing the flow of data in the cooperation support system disclosed in FIG. 1.

FIG. 7 is a view showing the overview of processes in the cooperation support system disclosed in FIG. 1.

FIG. 8 is a block diagram showing the hardware configuration of a cooperation support apparatus in a second example embodiment of the present invention.

FIG. 9 is a block diagram showing the configuration of the cooperation support apparatus in the second example embodiment of the present invention.

FIG. 10 is a flowchart showing the operation of the cooperation support apparatus in the second example embodiment of the present invention.

### DESCRIPTION OF EXAMPLE EMBODIMENTS

### First Example Embodiment

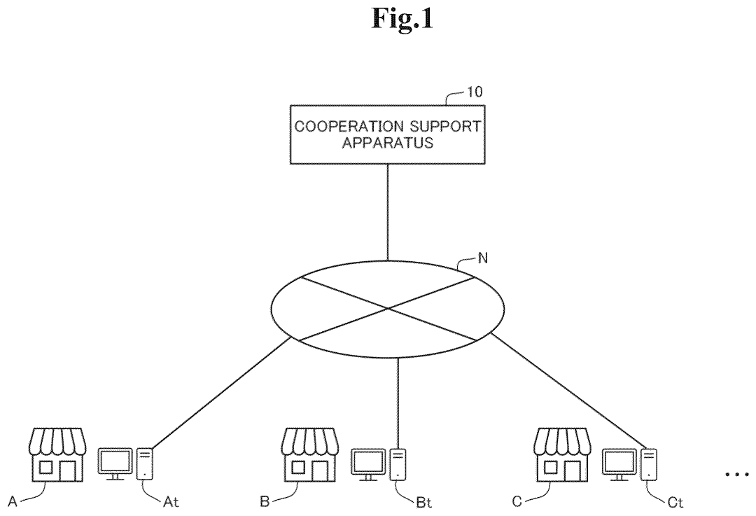

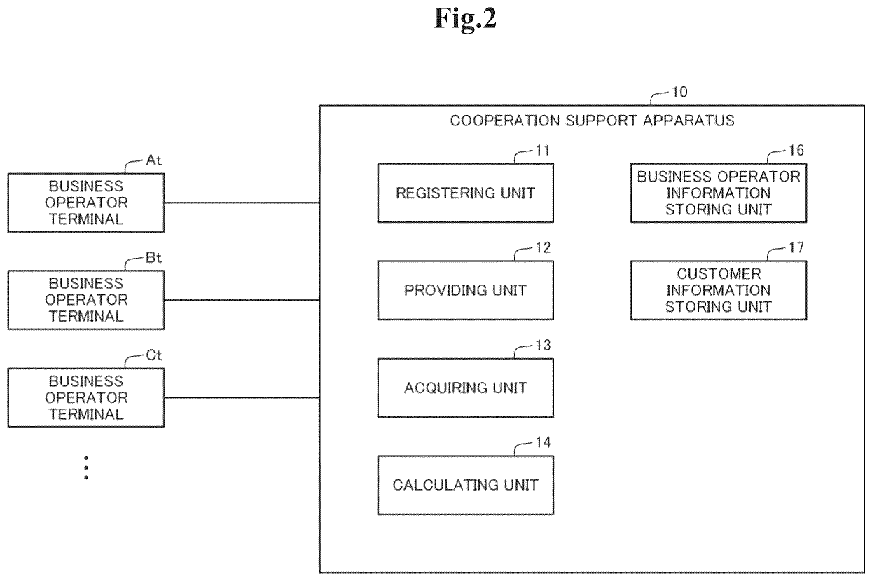

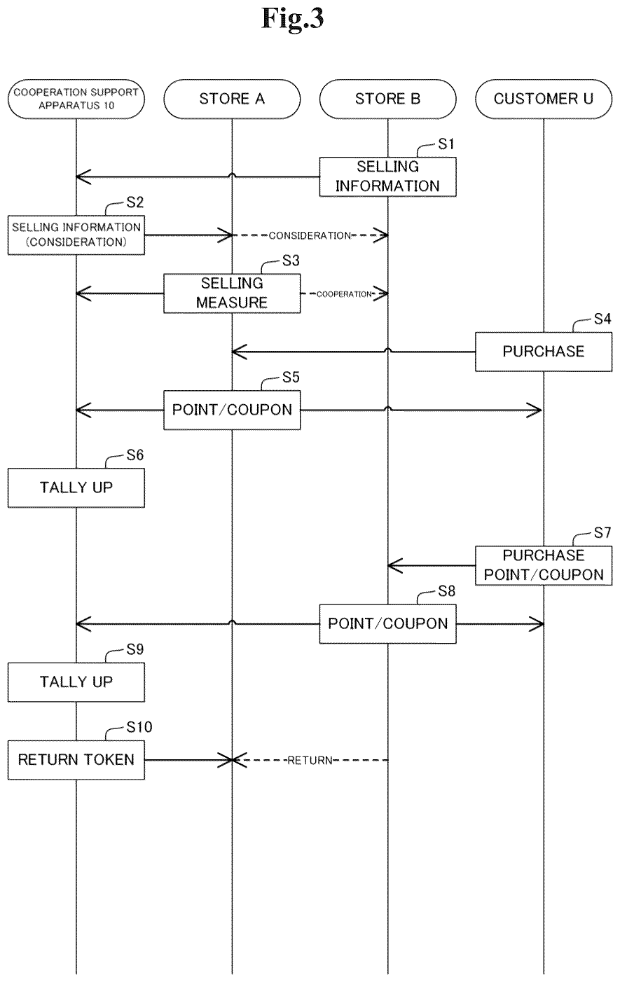

A first example embodiment of the present invention will be described with reference to FIGS. 1 to 7. FIGS. 1 and 2 are views for describing the configuration of a cooperation support system, and FIGS. 3 to 7 are views for describing the processing operation of the cooperation support system.

### [Configuration]

The cooperation support system according to the present invention is used for supporting selling cooperation between a plurality of business operators. For example, business operators include business operators that sell products or provide services at stores, business operators that wholesale products to retail stores or supply products to vending machines, and business operators that provide services without going through stores. In addition, selling in the present invention includes not only the selling of products but also the provision of services.

In a first example of this example embodiment, a case will be described in which three different business operators sell different products at different stores A, B, and C, respectively. At this time, it is assumed that the three business operators has consented that when a product is sold at any of the stores A, B, and C, a point according to a purchase amount is issued and given to a customer who has purchased the product, and that the point can be used to pay at any of the stores A, B and C of the three business operators. That is to say, it is assumed that the three business operators cooperate in advance on a common point system that allows use to pay for products. In addition to such a situation, the cooperation support system in this example embodiment supports further selling cooperation among the three business operators.

As shown in FIG. 1, the cooperation support system is configured by connecting a cooperation support apparatus 10 and business operator terminals At, Bt, and Ct that can be operated by employees of the stores A, B, and C of the three business operators via a network N.

The business operator terminals At, Bt, and Ct are each configured with one or a plurality of information processing apparatuses each including an arithmetic logic unit and a memory unit, and are connectable to the cooperation support apparatus 10 via the network N. Then, the business operator terminals At, Bt, and Ct can acquire information from the cooperation support apparatus 10 and register information in the cooperation support apparatus 10 in response to operations by the employees of the respective business operators.

Specifically, each of the business operator terminals At, Bt, and Ct has a function of registering “selling information” that is information about the selling of products at a store of the business operator in the cooperation support apparatus 10. For example, an employee of the business operator operates the business operator terminal to input “selling information”, which is transmitted to and registered in the cooperation support apparatus 10. For example, “selling information” is information that represents a selling method developed by the business operator to conduct promotion of the selling of products from the business operator, product information to be sold, and the like. Examples of “selling information” include campaign information such as discount selling, the value of token information having monetary value to be given to another business operator in return for selling cooperation by the other business operator, information introducing products to be sold, and the like. In addition, as will be described later, “selling information” is provided to another business operator for a fee. However, “selling information” may be provided for free.

Further, each of the business operator terminals At, Bt, and Ct has a function of registering “selling measure information” representing a selling measure in cooperation with another business operator in the selling of products at the store of the business operator, in the cooperation support apparatus 10. For example, an employee of the business operator operates the business operator terminal to input “selling measure information”, which is transmitted to and registered in the cooperation support apparatus 10. For example, “selling measure information” is a selling method which an employee or the like of the business operator develops by acquiring the abovementioned “selling information” of the other business operator and considering the content of the selling by the other business operator, and is information representing the content of a selling measure for the business operator and the other business operator to cooperate in selling and conduct promotion of the selling of products of the both. Examples of “selling measure information” include information representing that the business operator issues a coupon introducing a product from the other business operator to a customer who has visited the store of the business operator in time with a selling campaign by the other business operator, information representing that the business operator sets up the selling price of the business operator's product sold at the store of the other business operator in time with a campaign by the other business operator, and the like. In addition, when developed by the business operator, “selling measure information” may also be notified to the other business operator with which the business operator cooperates in selling.

Further, each of the business operator terminals At, Bt, and Ct has a function of registering “sales information” associated with the selling of products at the store of the business operator, in the cooperation support apparatus 10. For example, an employee of the business operator operates the business operator terminal to collect “sales information”, which is transmitted to and registered in the cooperation support apparatus 10. “Sales information” is information such as the prices of products sold to customers mainly at the store, points given to customers for payment, points used by customers for payment, and coupons presented by customers at the time of payment. Therefore, at the time of selling, the business operator terminal At, Bt, Ct reads identification information of a customer U from an application installed in a mobile terminal Ut carried by the customer U, a membership card, or the like, and transmits the identification information of the customer U and identification information of the store A, B, C along with the abovementioned amounts of money, points, and coupons to the cooperation support apparatus 10.

Further, each of the business operator terminals At, Bt, and Ct has a function of issuing a point to the customer U according to the price of a product sold at the store of the business operator. For example, the business operator terminal At, Bt, Ct performs a process of calculating a point according to the price of a product sold to the customer U and giving the point to the identification information of the customer U read from the mobile terminal Ut of the customer U. In addition, the business operator terminal At, Bt, Ct also performs a process of, at the time of selling a product to the customer U, reading coupon information presented by the customer U, collecting a point used for payment, and so forth. Then, the business operator terminal At, Bt, Ct includes the identification information of the customer U, point, coupon information and so forth processed at the time of selling the product to the customer U in the sales information and transmits the sales information to the cooperation support apparatus 10 as described above. However, the process such as giving points by the business operator terminals At, Bt, and Ct may be performed by the cooperation support apparatus 10. In this case, when selling a product to the customer U, the business operator terminal At, Bt, Ct transmits the price of the product, point to be used for payment, presented coupon information and so forth along with the identification information of the customer U to the cooperation support apparatus 10, and the cooperation support apparatus 10 may thereby perform the process such as giving points.

As the abovementioned points, points given in an existing point system may be used. Moreover, in this example embodiment, it is assumed that the business operator terminal At, Bt, Ct gives points to the customer U in accordance with the selling, but such points do not necessarily need to be explicitly shown to the customer U, and it is sufficient for the business operator terminal At, Bt, Ct and the cooperation support apparatus 10 to simply record information equivalent to the points. Moreover, the business operator terminal At, Bt, Ct does not necessarily need to give points, and it is sufficient for the business operator terminal At, Bt, Ct and the cooperation support apparatus 10 to simply record information representing a purchase status of each customer U, such as a purchase amount. In this case, the business operator terminal At, Bt, Ct and the cooperation support apparatus 10 may analyze a relation in selling cooperation between the stores based on the recorded point equivalence information and purchase status information of the customer U, as will be described later, and calculate token information.

Further, each of the business operator terminals At, Bt, and Ct has a function of acquiring, from the cooperation support apparatus 10, “selling information” of the other business operator registered in the cooperation support apparatus 10 as described above. For example, an employee of the business operator operates the business operator terminal At to access the cooperation support apparatus 10, views a list of “selling information” of the other business operator registered in the cooperation support apparatus 10, and selects and requests any “selling information” to acquire the “selling information”. At this time, the business operator having acquired “selling information” of the other business operator pays a consideration to the other business operator having provided “selling information”. For example, the business operator terminal At, Bt, Ct pays a consideration in accordance with a payment process performed by the cooperation support apparatus 10.

Further, each of the business operator terminals At, Bt, and Ct has a function of receiving payment from the cooperation support apparatus 10. For example, the business operator terminal receives payment of a consideration from the other business operator for providing the abovementioned “selling information” of the business operator to the other business operator, payment in return from the other business operator for implementing a selling cooperation measure for the other business operator, and so forth. As will described later, such return is based on token information having monetary value calculated based on the sales of the business operator with which selling cooperation has been conducted.

Next, the configuration of the cooperation support apparatus 10 will be described. The cooperation support apparatus 10 is configured to one or a plurality of information processing apparatuses each including an arithmetic logic unit and a memory unit. Then, as shown in FIG. 2, the cooperation support apparatus 10 includes a registering unit 11, a providing unit 12, an acquiring unit 13, and a calculating unit 14. The respective functions of the registering unit 11, the providing unit 12, the acquiring unit 13, and the calculating unit 14 can be realized by the arithmetic logic unit executing a program for realizing the respective functions stored in the memory unit. The cooperation support apparatus 10 also includes a business operator information storing unit 16 and a customer information storing unit 17. The business operator information storing unit 16 and the customer information storing unit 17 are configured with the memory unit.

The registering unit 11 stores and registers “selling information” on the selling of products at the stores of the respective business operators, which is information input and transmitted by the business operator terminals At, Bt, and Ct, into the business operator information storing unit 16. As described above, “selling information” is campaign information, token information to be returned, and so forth. As an example, it is assumed that campaign information of the store B is registered as “selling information” from the business operator terminal Bt of the store B.

The providing unit 12 provides, in response to a request from the business operator terminal At, Bt, Ct, “selling information” of the other business operator. As an example, in a case where “selling information” of the store B is requested by the business operator terminal At of the store A, the providing unit 12 provides “selling information” of the store B to the business operator terminal At of the store A. At this time, the providing unit 12 demands a consideration for providing “selling information” from the store A, performs a process of collecting the consideration from the store A and paying to the store B, and stores the settlement information into the business operator information storing unit 16.

The acquiring unit 13 acquires “selling measure information” input and transmitted by the business operator terminal At, Bt, Ct, and stores it into the business operator information storing unit 16. As described above, “selling measure information” is information such as the issuance of a coupon introducing a product from the other business operator, and the setting of the selling price of a product from the business operator. Here, as an example, it is assumed that “selling measure information” developed by the store A having received the provision of campaign information that is “selling information” of the store B is acquired from the business operator terminal At and registered. In this case, “selling measure information” is a selling measure that the store A gives a coupon introducing a product from the store B to a customer visiting the store A in order to conduct selling promotion for both the store A and the store B in time with the campaign by the store B.

Further, the acquiring unit 13 acquires “sales information” input and transmitted by the business operator terminal At, Bt, Ct, and stores it into the business operator information storing unit 16. As described above, “sales information” is information such as the amount of money of a product sold to a customer at the store, points given in response to payment by the customer, points used for payment by the customer, and a coupon presented at the time of payment by the customer. Here, as an example, it is assumed that “sales information” of the store B is acquired from the business operator terminal Bt. In this case, “sales information” includes the amount of money of a product sold to a customer at the store B, points given by the store B in response to payment by the customer, points used by the customer for payment at the store B, and coupon information issued by the store A to introduce a product from the store B and presented at the time of payment by the customer.

The calculating unit 14 performs a process of tallying up common points used in cooperation by the three stores A, B, and C, based on “sales information” input and transmitted by the business operator terminals At, Bt, and Ct. For example, the calculating unit 14 finds out information such as which store has given a point to which customer and which customer has used a point for payment at which store from information such as identification information of the customer U, identification information of the store A, B, C, the amount of money and the points contained in the sales information, tallies up the points held by each customer, associates the points held by each customer with information such as which store has given the points, and stores into the customer information storing unit 17. In the customer information storing unit 17, information on the customer U who has become a member of the common point system in advance is registered, and the information is associated with an application installed in the mobile terminal Ut owned by the customer U by an identification number or the like.

In addition, the calculating unit 14 may perform a process of giving points to each customer U by registering points transmitted by the business operator terminals At, Bt, and Ct for each customer U as described above, or may perform a process of actually giving points based on information such as the amount of money transmitted by the business operator terminals At, Bt, and Ct. That is to say, the calculating unit 14 cooperates with the business operator terminals At, Bt and Ct to perform the tallying process such as giving points.

Here, an example of giving points and tallying up points will be described. When the customer U purchases a 100 yen product at the store A, the store A gives 10 points to the customer U, and when the customer U purchases a 50 yen product at the store B, the store B gives 5 points to the customer U. In this case, the customer U holds a total of 15 points, and the calculating unit 14 stores 15 points in a state where 10 points is associated with the store A and 5 points is associated with the store B.

Further, the calculating unit 14 calculates token information having monetary value provided to one store from the other store based on “selling measure information” and “sales information”. Specifically, the calculating unit 14 first calculates the degree of contribution of issuance of a coupon by one store to sales of the other store based on information that the one store issues a coupon introducing the other store contained in “selling measure information” and information on a coupon and points used at the time of selling contained in “sales information”. For example, the calculating unit 14 calculates the degree of contribution of one store to the other store in accordance with the ratio of points associated with the one store to all the points held by the customer U. Furthermore, the calculating unit 14 calculates token information having monetary value provided to the one store from the other store in accordance with the calculated degree of contribution. That is to say, the token information has monetary value and is given to the one store in return for introduction by a coupon in accordance with the sales of the other store.

As an example, a case will be described in which the customer U uses a coupon that the store A introduces the store B to purchase a product at the store B and uses points for payment. At this time, it is assumed that as described above, the customer U has a total of 15 points and uses all 15 points for payment. In the same manner as described above, of 15 points held by the customer U, 10 points are associated with the store A and 5 points are associated with the store B. In this case, the calculating unit 14 calculates, from the points associated with the store A (10 points) of all the points held by the customer U (15 points), the degree of contribution of issuance of a coupon by the store A to the store B as 10/15=2/3. Then, the calculating unit 14 calculates token information with a value equivalent to 15×(2/3)=10 points from the points used by the customer U for payment at the store B (15 points) and the abovementioned degree of contribution (2/3). That is to say, in this case, as a result of introduction of the store B by the store A with a coupon, token information having monetary value given in return from the store B to the store A (equivalent to 10 points) of the points used for payment at the store B (15 points) is calculated.

Then, the calculating unit 14 transmits the token information calculated as described above to each business operator terminal and provides it to each store. In the above case, for example, monetary data of the store B is registered in advance in the cooperation support apparatus 10 and, from the monetary data, monetary data equivalent to the value of the calculated token information is paid to the store A. At this time, when the store B provides “selling information” to the store A, a consideration is paid from the store A to the store B, and the calculating unit 14 may offset monetary data associated with payment of the consideration with monetary data equivalent to the value of the token information.

Although the calculating unit 14 calculates the value of token information based on points held by the customer U in the above description, the calculating unit 14 may calculate the abovementioned degree of contribution and the value of token information based on the amount of money paid by the customer U at each store.

Further, the calculating unit 14 may calculate and update information on a token having monetary value provided by the other store contained in “selling information” of the other store, based on “selling measure information” and “sales information”. For example, in a case where “selling measure information” of the store A contains information that the store A issues a coupon introducing the store B, when the calculating unit 14 determines that the degree of contribution of the issuance of the coupon by the store A to the sales of the store B is high, based on information on the coupon and points used at the time of selling contained in “sales information” of the store B, the calculating unit 14 may calculate so as to increase the value of token information to be given in return and update the selling information of the store B.

Further, the calculating unit 14 may generate new “selling measure information” based on “selling measure information” and “sales information”. For example, in a case where “selling measure information” of the store A contains information that the store A issues a coupon introducing the store B, when the calculating unit 14 determines that the degree of contribution of the issuance of the coupon by the store A to the sales of the store B is high, based on information on the coupon and points used at the time of selling contained in “sales information” of the store B, the calculating unit 14 may generate new selling measure information on issuance of a coupon introducing still another store (for example, the store C). Then, the calculating unit 14 may transmit and propose the new selling measure information generated thereby to the business operator terminal At of the store A and, when the consent of the store A is obtained, the calculating unit 14 may register the information as the selling measure information of the store A as it is.

### [Operation]

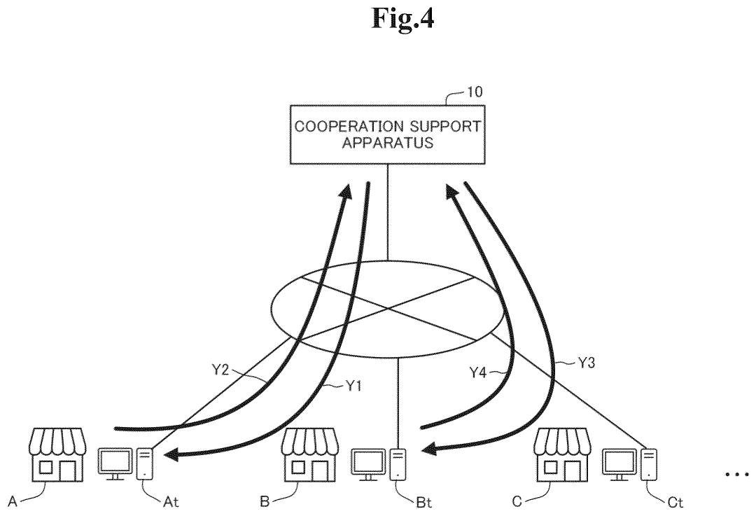

Next, the operation of the abovementioned cooperation support system will be described with reference to a sequence diagram of FIG. 3 and flow diagrams of FIGS. 4 to 7. The sequence diagram of FIG. 3 shows the operation of the stores A and B and omits the operation of the store C.

First, it is assumed that the three different stores A, B, and C cooperate with each other in issuing common points as described above. In addition, the customer U is registered as a user of the common points, and has an application for using the common points installed in the mobile terminal Ut.

Then, it is assumed that in order to conduct further sales cooperation, each of the stores A, B, and C registers “selling information” that is information on the selling of products at the store, in the cooperation support apparatus 10. “Selling information” is, for example, information that represents a selling method developed by each of the stores A, B, and C to conduct promotion of selling of products at the store and the content of the selling, and examples thereof include campaign information such as discount selling, and the value of token information having monetary value to be provided to the other business operator for selling cooperation by the other business operator. In this example, it is assumed that the store B has registered “selling information” containing campaign information such as discount selling and the value of token information to be given in return, in the cooperation support apparatus 10 (step S1 in FIG. 3). It is also assumed that the store C has registered “selling information” containing campaign information such as discount selling in the cooperation support apparatus 10.

In the above situation, it is assumed that the store A is considering further selling cooperation with the store B. In this case, the store A requests and acquires “selling information” of the store B from the cooperation support apparatus 10 (step S2 in FIG. 3, arrow Y1 in FIG. 4). At this time, the store A pays a consideration for provision of “selling information” to the store B. The payment of a consideration is made electronically via the cooperation support apparatus 10, for example.

Next, the store A considers the selling measure of the store A based on the campaign information and the value of token information to be given in return contained in “selling information” of the store B, and registers “selling measure information” representing the content of the decided selling measure in the cooperation support apparatus 10 (step S3 in FIG. 3, arrow Y2 in FIG. 4). For example, the store A registers a selling measure such as giving a coupon introducing a product from the store B to the customer U who visits the store A in conjunction with a campaign held by the store B. In addition, the selling measure implemented by the store A is also notified to the store B to be a cooperation partner.

Further, it is assumed that the store B is considering further selling cooperation with the store C in the same manner as described above. In this case, the store B requests and acquires “selling information” of the store C from the cooperation support apparatus 10 (arrow Y3 in FIG. 4). Then, the store B considers the selling measure of the store B based on the campaign information contained in “selling information” of the store C, and registers “selling measure information” representing the content of the decided selling measure in the cooperation support apparatus 10 (arrow Y4 in FIG. 4).

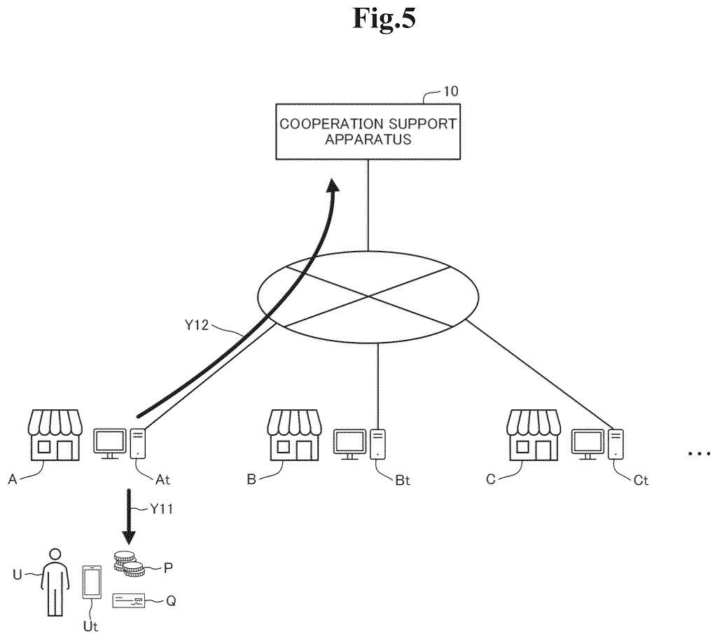

After that, as shown in FIG. 5, it is assumed that the customer U purchases a product at the store A (step S4 in FIG. 3). At this time, the customer U presents identification information of the customer U on the mobile terminal Ut, and the store A reads the identification information of the customer U with the business operator terminal At and inputs the price of the product to perform a settlement process. Consequently, a point P according to the settlement amount of money and a coupon Q introducing the store B from the store A are issued to the customer U from the business operator terminal At of the store A, and are stored into the mobile terminal Ut (arrow Y11 in FIG. 5). In conjunction with this, the business operator terminal At of the store A transmits “sales information” relating to the selling, such as the identification information of the customer U, identification information of the store A, the selling amount of money, and the point, to the cooperation support apparatus 10 (step S5 in FIG. 3, arrow Y12 in FIG. 5).

The cooperation support apparatus 10 performs a process of tallying up common points based on “sales information” transmitted from the business operator terminal At of the store A (step S6 in FIG. 3). As an example, in a case where the customer U purchases a 100 yen product at the store A and the store A gives 10 points to the customer U, the customer U holds a total of 10 points, of which 10 points will be tallied and stored in association with the store A.

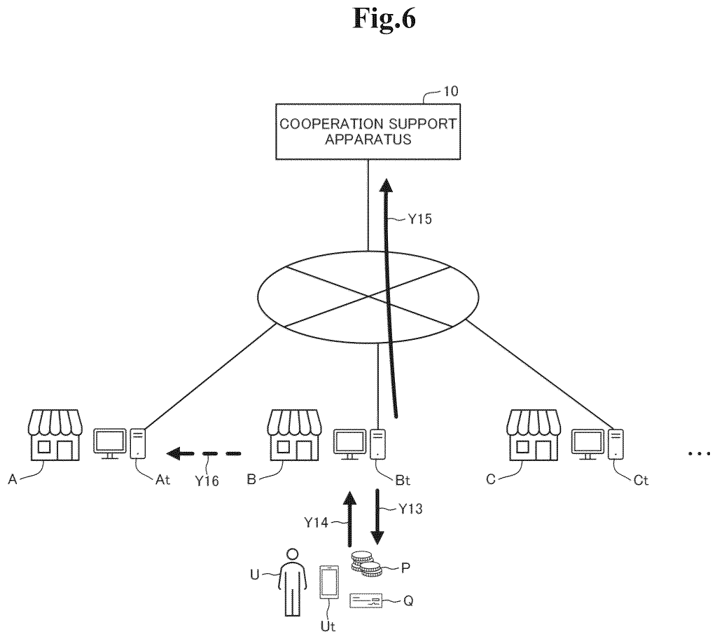

After that, as shown in FIG. 6, it is assumed that the customer U purchases a product at the store B (step S7 in FIG. 3). At this time, the customer U presents the identification information of the customer U and the coupon introducing the store B having been issued by the store A for the previous purchase on the mobile terminal Ut, and the store B reads the identification information of the customer U and the coupon with the business operator terminal Bt and inputs the price of the product to perform a settlement process. Consequently, a point P according to the settlement amount of money and a coupon Q introducing the store C from the store B are issued to the customer U from the business operator terminal Bt of the store B, and are stored in the mobile terminal Ut (arrow Y13 in FIG. 6). At this time, it is assumed that the customer U uses points held thereby for payment to the store B (arrow Y14 in FIG. 6). Then, in conjunction with this, the business operator terminal Bt of the store B transmits “sales information” relating to the selling, such as the identification information of the customer U, identification information of the store B, the selling amount of money, the point, and the coupon, to the cooperation support apparatus 10 (step S8 in FIG. 3, arrow Y15 in FIG. 6).

The cooperation support apparatus 10 performs a process of tallying up common points based on “sales information” transmitted from the business operator terminal Bt of the store B (step S9 in FIG. 3). As an example, in a case where the customer U purchases a 50 yen product at the store B and the store B gives 5 points to the customer U, the customer U holds a total of 15 points, which are tallied up and stored in a manner that 10 points are associated with the store A and 5 points are associated with the store B.

At this time, the customer U uses the coupon introducing the store B from the store A and also uses the points to pay the store B, so that the cooperation support apparatus 10 further calculates the value of token information to be given in return to the store A by the store B based on “selling cooperation information”. As an example, it is assumed that the customer U holds 15 points and uses all 15 points to pay the store B. At this time, of 15 points held by the customer U, 10 points are associated with the store A and 5 points are associated with the store B. In this case, the cooperation support apparatus 10 calculates the degree of contribution of the store A by issuing the coupon to the store B as 10/15=2/3, from the points associated with the store A (10 points) of all the points held by the customer U (15 points). Then, the cooperation support apparatus 10 calculates token information with a value equivalent to 15×(2/3)=10 points from the points used by the customer U to pay the store B (15 points) and the abovementioned degree of contribution (2/3).

Then, the cooperation support apparatus 10 stores the calculated token information so as to provide it to the store A (step S10 in FIG. 3). Consequently, money or a token having monetary value equivalent to the value of the calculated token information is given in return to the store A by the store B (arrow Y16 in FIG. 6).

Here, as another example that is different from the above, a case will be described in which the customer U purchases a product with a different price and uses points with a different value. For example, in the example shown in FIG. 5, in a case where the customer U purchases a 200 yen product at the store A and 20 points are given to the customer U by the store A, the customer U holds a total of 20 points, of which 20 points are associated with the store A. After that, in the example shown in FIG. 6, in a case where the customer U purchases a 100 yen product at the store B and 10 points are given to the customer U by the store B, the customer U holds a total of 30 points, of which 10 points are associated with the store B. In such a situation, it is assumed that the customer U uses a coupon introducing the store B by the store A and uses 15 points to pay the store B. At this time, of 30 points held by the customer U, 20 points are associated with the store A and 10 points are associated with the store B. In this case, the cooperation support apparatus 10 calculates the degree of contribution of the store A by issuing the coupon to the store B, as 20/30=2/3, from the points associated with the store A (20 points) of all the points held by the customer U (30 points). Then, the cooperation support apparatus 10 calculates token information with a value equivalent to 15×(2/3)=10 points from the points used by the customer U to pay the store B (15 points) and the abovementioned degree of contribution (2/3). Thus, token information having monetary value equivalent to the calculated 10 points is given in return to the store A by the store B. The customer U still holds 15 points, and 10 points according to the degree of contribution are deducted from 20 points associated with the store A and 10 points remain associated with the store A, and 5 points remain associated with the store B.

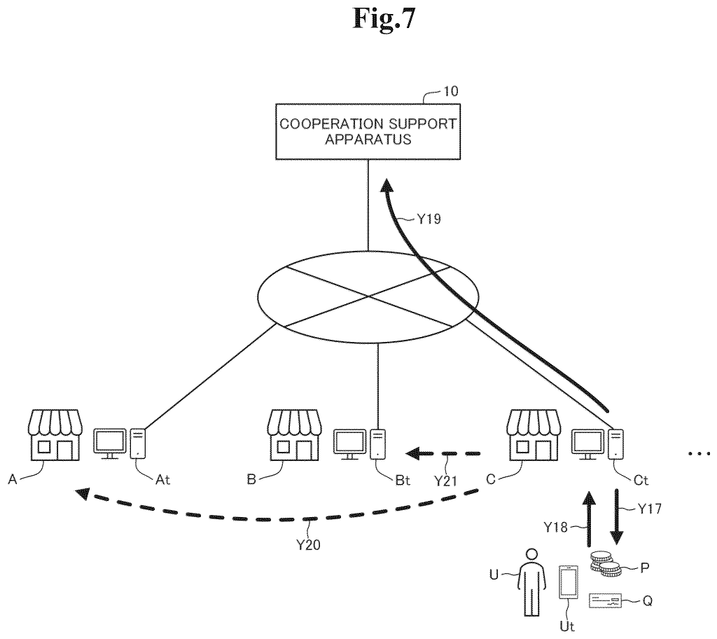

Then, further in the abovementioned situation, in a case where, as shown in FIG. 7, the customer U purchases a 400 yen product at the store C and the store C gives 40 points to the customer U (arrow Y17 in FIG. 7), the customer U holds a total of 55 points, of which 10 points are associated with the store A, 5 points are associated with the store B, and 40 points are associated with the store C. Then, at this time, it is assumed that the customer U uses a coupon introducing the store C by the store B and uses 30 points to pay the store C (arrow Y18 in FIG. 7). Then, when the store C transmits the abovementioned sales information to the cooperation support apparatus 10 (arrow Y19 in FIG. 7), the cooperation support apparatus 10 calculates token information to be given in return to the respective stores A and B by the store C in the following manner. First, for the store A, (10/55)×30 points is found, and token information equivalent to 5.5 points is calculated (arrow Y20 in FIG. 7). For the store B, (5/55)×30 points is found, and token information equivalent to 2.7 points is calculated (arrow Y21 in FIG. 7).

Thus, in this example embodiment, by providing the selling information of a second business operator to a first business operator, cooperation with the second business operator by the first business operator is promoted, and a selling measure of the first business operator in cooperation with the second business operator is set up. Then, token information to be given in return to the first business operator by the second business operator is calculated according to the selling measure of the first business operator and the sales of the second business operator. Consequently, incentive for cooperation between the business operators increases, and promotion of selling cooperation can be conducted.

### Other Example

Next, a case will be described in which business operators are different from those in the above case in the abovementioned cooperation support system. In this case, business operators D, E, and F are used instead of the abovementioned stores A, B, and C. For example, the business operator D is a business operator that provides “electricity” for charging electric vehicles, and the business operator E is a business operator serving as “retail store” in which a charger for electric vehicles is installed. Moreover, the business operator F is “distribution business operator” that runs a delivery business using electric vehicles.

The business operator D that provides electricity to electric vehicles via a charger acquires selling campaign information, which is “selling information” of the business operator E serving as a retail store in which a charger for charging electricity provided by the business operator D is installed, via the cooperation support apparatus 10. Then, the business operator D considers a measure for selling electricity using the charger that the business operator D has installed in the store of the business operator E, based on the selling campaign information of the business operator E, and registers such “selling measure information” in the cooperation support apparatus 10. For example, the business operator D develops a selling measure to take advantage of an ability to attract customers of the business operator E that is currently running a sales campaign and lower a rate for changing electricity by the charger installed in the store of the operator E, and expects an increase of the sales of electricity by the business operator D and a further increase of the number of visitors to the store of the business operator E in conjunction with the lowered changing rate. In addition, the business operator D may advertise, to its own customers who charge their electric vehicles, the lowered charging rate at the store of the business operator E.

After that, the business operator E which the business operator D has cooperated with and has set up the selling measure for registers “sales information” of its store in the cooperation support apparatus 10. Then, in the case of determining that there is a relation between reduction of the charging rate by the business operator D that is “selling measure information” and increase of the sales of the store of the operator E, the cooperation support apparatus 10 calculates token information having monetary value to be given in return by the business operator E to the business operator D based on the sales amount of money of the business operator E. For example, in a case where the sales of the business operator E become more than other periods during a period in which the business operator D has reduced the rate for charging by the charger installed in the store of the business operator E, or in a case where customers who use the charger installed in the store of the business operator E purchase products related to the store of the business operator E, the cooperation support apparatus 10 determines that there is a relation therebetween and calculates token information to be given in return by the business operator E to the business operator D.

Further, the business operator D that provides electricity for charging electric vehicles acquires, for example, information on delivery area, delivery route and charging spot as “selling information” of the business operator F that runs a delivery business, via the cooperation support apparatus 10. Then, the business operator D considers a measure for selling electricity provided by the business operator D based on the information on delivery area, route and charging spot of the business operator F, and registers such “selling measure information” in the cooperation support apparatus 10. For example, the business operator D develops a selling measure to lower a rate for charging by the charger installed in the store of the business operator E, and expects increase of the sales in selling electricity by the business operator D and increase of requests by the store of the business operator E for delivery by the business operator F in conjunction with the lowered charging rate.

After that, the business operator F which the business operator D has cooperated with and has set up a selling measure for registers “sales information” accompanying a delivery request in the cooperation support apparatus 10. Then, in the case of determining that there is a relation between reduction of the charging rate by the business operator D that is “selling measure information” and increase of the sales in delivery by the business operator F, the cooperation support apparatus 10 calculates token information having monetary value to be given in return by the business operator F to the business operator D based on the sales amount of money of the business operator F. For example, in a case where, during a period in which the business operator D lowers a rate for charging by the charger installed in the store of the business operator E, the business operator F uses the charger in the store of the business operator E and the business operator F accepts requests for delivery from the business operator E to thereby increase the sales, the cooperation support apparatus 10 determines that there is a relation and calculates token information to be given in return by the business operator F to the business operator D.

Further, the business operator F can acquire store delivery charge information as “selling information” of the business operator E and register “selling measure information” proposing reduction of delivery charge. Consequently, it is conceivable that the business operator F reduces its delivery charge and thereby the sales by online shopping at the store of the business operator E increases. Therefore, in a case where there is such a relation, token information to be given in return from the business operator E to the business operator F is calculated.

Thus, in the abovementioned other example, by providing the selling information of a second business operator to a first business operator, cooperation by the first business operator with the second business operator is promoted, and a selling measure of the first business operator in cooperation with the second business operator is set up. Then, token information to be given in return from the second business operator to the first business operator is calculated according to the selling measure of the first business operator and the sales of the second business operator. This will increase the incentive of business operators to cooperate with each other and conduct promotion of selling cooperation.

### Second Example Embodiment

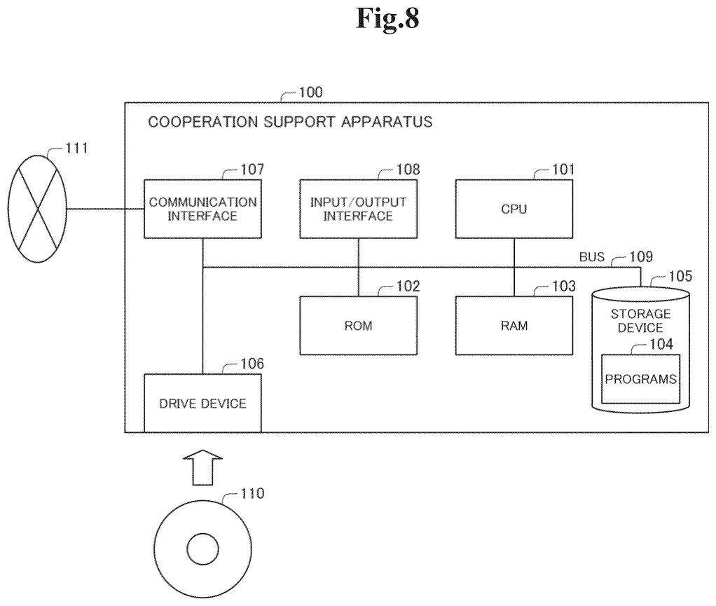

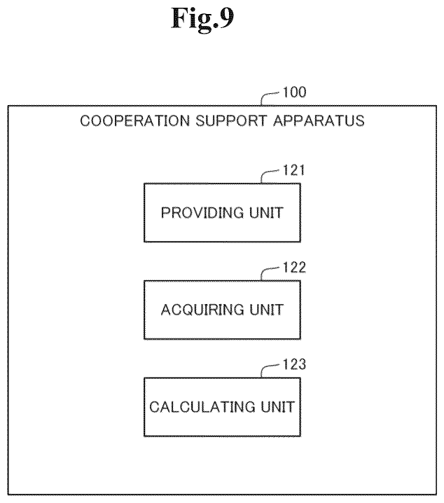

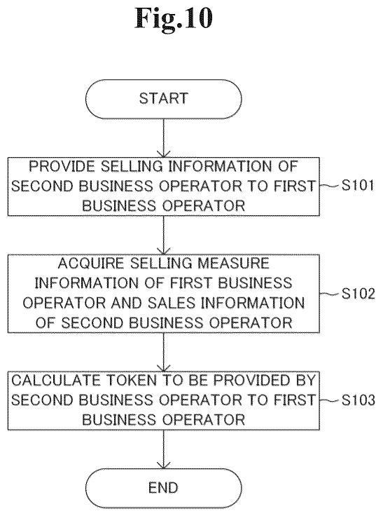

Next, a second example embodiment of the present invention will be described with reference to FIGS. 8 to 10. FIGS. 8 and 9 are block diagrams showing the configuration of a cooperation support apparatus in the second example embodiment, and FIG. 10 is a flowchart showing the operation of the cooperation support apparatus. In this example embodiment, the overview of the configuration of the cooperation support apparatus described in the above example embodiment is shown.

First, the hardware configuration of a cooperation support apparatus 100 in this example embodiment will be described with reference to FIG. 8. The cooperation support apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded to the RAM 103;
a storage device 105 storing the programs 104;
a drive device 106 that reads from and writes into a storage medium 110 outside the information processing apparatus;
a communication interface 107 connected to a communication network 111 outside the information processing apparatus;
an input/output interface 108 that inputs and outputs data; and
a bus 109 connecting the respective components.

Then, the cooperation support apparatus 100 can build and include a providing unit 121, an acquiring unit 122, and a calculating unit 123 shown in FIG. 9 by acquisition and execution of the programs 104 by the CPU 101. The programs 104 are, for example, stored in advance in the storage device 105 or the ROM 102, and loaded to the RAM 103 and executed by the CPU 101 as necessary. Moreover, the programs 104 may be provided to the CPU 101 via the communication network 111, or the programs 104 may be stored in advance in the storage medium 110 and read out by the drive device 106 and provided to the CPU 101. However, the providing unit 121, the acquiring unit 122, and the calculating unit 123 described above may be built by a dedicated electronic circuit for realizing such means.

FIG. 8 shows an example of the hardware configuration of the information processing apparatus serving as the cooperation support apparatus 100, and the hardware configuration of the information processing apparatus is not limited to the abovementioned case. For example, the information processing apparatus may include part of the abovementioned configuration, such as without the drive device 106.

Then, the cooperation support apparatus 100 executes a service building method shown in the flowchart of FIG. 10 by the functions of the providing unit 121, the acquiring unit 122, and the calculating unit 123 built by the program as described above.

As shown in FIG. 10, a cooperation support apparatus executes processes to:
provide selling information to an information processing apparatus of a first business operator, the selling information representing information on selling by a second business operator registered in advance (step S101);
acquire selling measure information representing a selling measure in cooperation with the second business operator by the first business operator, and sales information on the selling by the second business operator (step S102); and
calculate token information having monetary value to be provided by the second business operator to the first business operator based on the selling measure information by the first business operator and the sales information by the second business operator (step S103).

Here, the selling information is, for example, selling campaign information by the second business operator, token information given in return for selling cooperation, and the like. Moreover, the selling measure information is a measure for selling by the first business operator having received provision of the selling information of the second business operator, which has advantages for both the first business operator and the second business operator.

Configured as described above, the present invention provides the selling information of the second business operator to the first business operator, and thereby promotes cooperation with the second business operator by the first business operator, so that a selling measure by the first business operator in cooperation with the second business operator is set up. Then, token information to be given in return by the second business operator to the first business operator is calculated in accordance with the selling measure of the first business operator and the sales of the second business operator. Consequently, the incentive of business operators to cooperate increases, and promotion of selling cooperation can be conducted.

The abovementioned program can be stored using various types of non-transitory computer-readable mediums and provided to a computer. Non-transitory computer-readable mediums include various types of tangible storage mediums. Examples of non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory). Moreover, the program may be provided to a computer by various types of transitory computer-readable mediums. Examples of transitory computer-readable mediums include an electric signal, an optical signal, and an electromagnetic wave. Transitory computer-readable mediums can provide the program to a computer via a wired communication path such as an electric wire and an optical fiber or a wireless communication path.

Although the present invention has been described above with reference to the example embodiments and so forth, the present invention is not limited to the above example embodiments. The configuration and details of the present invention can be changed in various manners that can be understood by one skilled in the art within the scope of the present invention. Moreover, at least one or more of the functions of the providing unit 121, the acquiring unit 122, and the calculating unit 123 described above may be executed by an information processing apparatus installed and connected anywhere on the network, that is, may be executed by so-called cloud computing.

### <Supplementary Notes>

The whole or part of the example embodiments disclosed above can be described as the following supplementary notes. Below, the overview of the configurations of a cooperation support method, a cooperation support apparatus, and a program according to the present invention will be described. However, the present invention is not limited to the following configurations.

### (Supplementary Note 1)

A cooperation support method comprising:
providing a first business operator with previously registered selling information representing information on selling by a second business operator;
acquiring selling measure information representing a selling measure in cooperation with the second business operator by the first business operator, and sales information relating to selling by the second business operator; and
calculating token information having monetary value to be provided by the second business operator to the first business operator, based on the selling measure information by the first business operator and the sales information by the second business operator.

### (Supplementary Note 2)

The cooperation support method according to Supplementary Note 1, comprising
providing the first business operator with the selling information containing information on a value of the token information having monetary value to be provided by the second business operator.

### (Supplementary Note 3)

The cooperation support method according to Supplementary Note 1, comprising
acquiring the selling measure information representing that a customer of the first business operator is provided with introduction information introducing the second business operator by the first business operator.

### (Supplementary Note 4)

The cooperation support method according to Supplementary Note 1, comprising
acquiring the selling measure information representing that a selling price by the first business operator selling at a place where the second business operator sells is to be set up.

### (Supplementary Note 5)

The cooperation support method according to Supplementary Note 1, comprising
calculating a degree of contribution of the selling measure of the first business operator to sales of the second business operator based on the selling measure information by the first business operator and the sales information by the second business operator, and calculating a value of the token information to be provided by the second business operator to the first business operator, based on the degree of contribution.

### (Supplementary Note 6)

The cooperation support method according to Supplementary Note 1, comprising:
issuing a point to a customer according to each of selling by the first business operator and selling by the second business operator, and storing the customer to whom the point has been issued and the first business operator or the second business operator having issued the point in association with point information corresponding the point; and furthermore
when the point is used to pay for selling by the second business operator, calculating a value of the token information to be provided by the second business operator to the first business operator, based on a ratio of the point associated with the first business operator to all the points held by the customer having used the point and a value of the point that the customer has used to pay for selling by the second business operator.

### (Supplementary Note 7)

The cooperation support method according to Supplementary Note 2, comprising
calculating information on the value of the token information to be provided by the second business operator, contained in the selling information of the second business operator, based on the selling measure information by the first business operator and the sales information by the second business operator.

### (Supplementary Note 8)

The cooperation support method according to Supplementary Note 1, comprising
newly generating the selling measure information based on the selling measure information by the first business operator and the sales information by the second business operator.

### (Supplementary Note 9)

A cooperation support apparatus comprising:
a providing unit that provides a first business operator with previously registered selling information representing information on selling by a second business operator;
an acquiring unit that acquires selling measure information representing a selling measure in cooperation with the second business operator by the first business operator, and sales information relating to selling by the second business operator; and
a calculating unit that calculates token information having monetary value to be provided by the second business operator to the first business operator, based on the selling measure information by the first business operator and the sales information by the second business operator.

### (Supplementary Note 10)

A computer program comprising instructions for causing a computer to execute processes to:
provide a first business operator with previously registered selling information representing information on selling by a second business operator;
acquire selling measure information representing a selling measure in cooperation with the second business operator by the first business operator, and sales information relating to selling by the second business operator; and
calculate token information having monetary value to be provided by the second business operator to the first business operator, based on the selling measure information by the first business operator and the sales information by the second business operator.

### (Supplementary Note 11)

The cooperation support apparatus according to claim 9, wherein
the providing unit provides the first business operator with the selling information containing information on a value of the token information having monetary value to be provided by the second business operator.

### (Supplementary Note 12)

The cooperation support apparatus according to Supplementary Note 9, wherein
the acquiring unit acquires the selling measure information representing that a customer of the first business operator is provided with introduction information introducing the second business operator by the first business operator.

### (Supplementary Note 13)

The cooperation support apparatus according to Supplementary Note 9, wherein
the acquiring unit acquires the selling measure information representing that a selling price by the first business operator selling at a place where the second business operator sells is to be set up.

### (Supplementary Note 14)

The cooperation support apparatus according to Supplementary Note 9, wherein
the calculating unit calculates a degree of contribution of the selling measure of the first business operator to sales of the second business operator based on the selling measure information by the first business operator and the sales information by the second business operator, and calculates a value of the token information to be provided by the second business operator to the first business operator, based on the degree of contribution.

### (Supplementary Note 15)

The cooperation support apparatus according to Supplementary Note 9, wherein:
the calculating unit issues a point to a customer according to each of selling by the first business operator and selling by the second business operator, and stores the customer to whom the point has been issued and the first business operator or the second business operator having issued the point in association with point information corresponding the point; and furthermore
when the point is used to pay for selling by the second business operator, the calculating unit calculates a value of the token information to be provided by the second business operator to the first business operator, based on a ratio of the point associated with the first business operator to all the points held by the customer having used the point and a value of the point that the customer has used to pay for selling by the second business operator.

### (Supplementary Note 16)

The cooperation support apparatus according to Supplementary Note 11, wherein
the calculating unit calculates information on the value of the token information to be provided by the second business operator, contained in the selling information of the second business operator, based on the selling measure information by the first business operator and the sales information by the second business operator.

### (Supplementary Note 17)

The cooperation support apparatus according to Supplementary Note 9, wherein
the calculating unit newly generates the selling measure information based on the selling measure information by the first business operator and the sales information by the second business operator.

The present invention is based upon and claims the benefit of priority from Japanese patent application No. 2022-071414, filed on Apr. 25, 2022, the disclosure of which is incorporated herein in its entirety by reference.

### REFERENCE SIGNS LIST

10 cooperation support system
11 registering unit
12 providing unit
13 acquiring unit
14 calculating unit
16 business operator information storing unit
17 customer information storing unit
A, B, C store
At, Bt, Ct business operator terminal
N network
100 cooperation support apparatus
101 CPU
102 ROM
103 RAM
104 programs
105 storage device
106 drive device
107 communication interface
108 input/output interface
109 bus
110 storage medium
111 communication network
121 providing unit
122 acquiring unit
123 calculating unit

What is claimed is:

1. A cooperation support method comprising:
providing a first business operator with previously registered selling information representing information on selling by a second business operator;
acquiring selling measure information representing a selling measure in cooperation with the second business operator by the first business operator, and sales information relating to selling by the second business operator; and
calculating token information having monetary value to be provided by the second business operator to the first business operator, based on the selling measure information by the first business operator and the sales information by the second business operator.

2. The cooperation support method according to claim 1, comprising
providing the first business operator with the selling information containing information on a value of the token information having monetary value to be provided by the second business operator.

3. The cooperation support method according to claim 1, comprising
acquiring the selling measure information representing that a customer of the first business operator is provided with introduction information introducing the second business operator by the first business operator.

4. The cooperation support method according to claim 1, comprising
acquiring the selling measure information representing that a selling price by the first business operator selling at a place where the second business operator sells is to be set up.

5. The cooperation support method according to claim 1, comprising
calculating a degree of contribution of the selling measure of the first business operator to sales of the second business operator based on the selling measure information by the first business operator and the sales information by the second business operator, and calculating a value of the token information to be provided by the second business operator to the first business operator, based on the degree of contribution.

6. The cooperation support method according to claim 1, comprising:
issuing a point to a customer according to each of selling by the first business operator and selling by the second business operator, and storing the customer to whom the point has been issued and the first business operator or the second business operator having issued the point in association with point information corresponding the point; and furthermore
when the point is used to pay for selling by the second business operator, calculating a value of the token information to be provided by the second business operator to the first business operator, based on a ratio of the point associated with the first business operator to all the points held by the customer having used the point and a value of the point that the customer has used to pay for selling by the second business operator.

7. The cooperation support method according to claim 2, comprising
calculating information on the value of the token information to be provided by the second business operator, contained in the selling information of the second business operator, based on the selling measure information by the first business operator and the sales information by the second business operator.

8. The cooperation support method according to claim 1, comprising
newly generating the selling measure information based on the selling measure information by the first business operator and the sales information by the second business operator.

9. A cooperation support apparatus comprising:
at least one memory storing processing instructions; and
at least one processor configured to execute the processing instructions to:
provide a first business operator with previously registered selling information representing information on selling by a second business operator;
acquire selling measure information representing a selling measure in cooperation with the second business operator by the first business operator, and sales information relating to selling by the second business operator; and
calculate token information having monetary value to be provided by the second business operator to the first business operator, based on the selling measure information by the first business operator and the sales information by the second business operator.

10. The cooperation support apparatus according to claim 9, wherein the at least one processor is configured to execute the processing instructions to
provide the first business operator with the selling information containing information on a value of the token information having monetary value to be provided by the second business operator.

11. The cooperation support apparatus according to claim 9, wherein the at least one processor is configured to execute the processing instructions to
acquire the selling measure information representing that a customer of the first business operator is provided with introduction information introducing the second business operator by the first business operator.

12. The cooperation support apparatus according to claim 9, wherein the at least one processor is configured to execute the processing instructions to
acquire the selling measure information representing that a selling price by the first business operator selling at a place where the second business operator sells is to be set up.

13. The cooperation support apparatus according to claim 9, wherein the at least one processor is configured to execute the processing instructions to
calculate a degree of contribution of the selling measure of the first business operator to sales of the second business operator based on the selling measure information by the first business operator and the sales information by the second business operator, and calculate a value of the token information to be provided by the second business operator to the first business operator, based on the degree of contribution.

14. The cooperation support apparatus according to claim 9, wherein the at least one processor is configured to execute the processing instructions to:
issue a point to a customer according to each of selling by the first business operator and selling by the second business operator, and store the customer to whom the point has been issued and the first business operator or the second business operator having issued the point in association with point information corresponding the point; and furthermore
when the point is used to pay for selling by the second business operator, calculate a value of the token information to be provided by the second business operator to the first business operator, based on a ratio of the point associated with the first business operator to all the points held by the customer having used the point and a value of the point that the customer has used to pay for selling by the second business operator.

15. The cooperation support apparatus according to claim 10, wherein the at least one processor is configured to execute the processing instructions to
calculate information on the value of the token information to be provided by the second business operator, contained in the selling information of the second business operator, based on the selling measure information by the first business operator and the sales information by the second business operator.

16. The cooperation support apparatus according to claim 9, wherein the at least one processor is configured to execute the processing instructions to
newly generate the selling measure information based on the selling measure information by the first business operator and the sales information by the second business operator.

17. A non-transitory computer-readable storage medium storing a program, the program comprising instructions for causing a computer to execute processes to:
provide a first business operator with previously registered selling information representing information on selling by a second business operator;
acquire selling measure information representing a selling measure in cooperation with the second business operator by the first business operator, and sales information relating to selling by the second business operator; and
calculate token information having monetary value to be provided by the second business operator to the first business operator, based on the selling measure information by the first business operator and the sales information by the second business operator.
